(19) United States
(12) Patent Application Publication
(10) Pub. No.: US 2001/0048968 A1
(43) Pub. Date: Dec. 6, 2001

(54) Ink-jet printing of gradient-index microlenses

(76) Inventors: W. Royall Cox, Plano, TX (US); Chi Guan, Richardson, TX (US)

Correspondence Address: Harry J. Watson, Locke Liddell & Sapp LLP, 2200 Ross Ave, Suite 2200, Dallas, TX, 75201, US

(21) Appl. No.: 09/782,215

(22) Filed: Feb. 13, 2001

Related U.S. Application Data
(60) Provisional application No. 60/182,736, filed on Feb. 16, 2000.

(51) Int. Cl. B05D 3/02; B05D 1/36; B05D 3/06; B05D 5/06

(52) U.S. Cl. 427/162; 427/407.1; 427/385.5; 427/558

(57) ABSTRACT

A process is disclosed which utilizes ink-jet printing of optical polymeric fluids to produce microlenses on a substrate having an axial gradient index of refraction. Two optical polymeric fluids are used, one having an index of refraction higher than the other. A base portion of the microlens is printed using the lower index of refraction material and a cap portion of the microlens is printed over the base portion to produce a radiused formed microlens. Inter-diffusion of the base portion and top or cap portion creates a generally uniform gradient diffusion zone in the axial (vertical) direction wherein the lower boundary of the zone has the index of the base portion and the upper boundary of the zone has the index of the top portion. After a sufficient gradient diffusion zone is formed, the formed microlens is solidified by curing or other means to stop any further diffusion. The microlenses may be formed as individual lenses on a optical substrate or as an array of microlenses. The gradient index microlenses produced by the method focus at a smaller focal point than single-index lenses.

### CROSS-REFERENCE TO RELATED APPLICATION

This application is a continuation-in-part of Provisional Application 60/182,736, filed Feb. 16, 2000 by the same inventors for which priority benefit is claimed.

### BACKGROUND OF THE INVENTION

1. Field of the Invention

The invention relates to improved microlens making procedures, especially microlenses with gradient refraction indexes, using ink-jet technology.

2. Background of the Prior Art

Arrays of microlenses are useful in making “free space” optical connections for datacom and telecom applications. By this is meant the transmission of light signals across an air gap to a receiver or detection device. Such arrays can be used to transmit light from optical fibers across free space to a defraction grating for separation of light signals. Delicacy of some devices, such as defraction gratings, effectively prohibits making direct connections with light signal transmission devices. Of particular interest is an array of microlenses which have very low levels of spherical aberrations which produce a very small focal spot, improving the accuracy and ability to control the transmission of light signals. Gradient index lenses are known to provide these benefits.

The concept of continuously changing index of refraction within a glass optical element for steering of light has been widely employed in several applications. For example, rod-shaped lenses having radially oriented index gradients for collimation of axially transmitted light have been commercially available for some time. This type of radial gradient index lens is fabricated by diffusion of smaller sized ions into a glass rod so as to reduce its index of refraction in proportion to the density of the host ions, resulting in an index which varies inversely with radial distance from the center of the rod. Alternatively, diffusion of larger sized ions into, or photothermoinduced crystallization of, lithographically defined circular areas of a glass plate are utilized to create arrays of planar microlenses, where the index gradient alone provides beam steering effects similar to an equivalently sized plano-convex lenslet with a spherical contour and a uniform index of refraction. Drawbacks to such planar axially gradient index of refraction microlenses include lower focusing efficiency (speed=focal length÷diameter) than plano-convex lenslets and degradation over long periods of time due to continued diffusion of implanted ions into the glass slab. Similarly, plano-convex axially gradient index of refraction lenses greater than several millimeters in diameter (verses microlenses) have been fabricated for several years by stacking and heating to the flow-point glass plates of differing index, then core-drilling to the desired lens diameter.

In summary, methods for fabricating, in glass, both arrays of planar microlenses and stand-alone, larger diameter lenses having axial gradient indexes of refraction are well established. However, no methods for fabricating axially gradient refractive index lenses or microlenses in optical organic plastic materials, are believed to be known. Methods for printing micro-optical components onto optical substrates using optical polymers have been disclosed in U.S. Pat. Nos. 5,498,444, Mar. 12, 1996 and 5,707,684, Jan. 13, 1998 entitled Method for Producing Micro-Optical Components by the assignee herein. These patents are incorporated herein by reference. This invention carries the technology further by disclosing methods of making axially gradient index of refraction microlenses for optical arrays using optical polymeric fluid and ink-jet printing techniques.

### SUMMARY OF THE INVENTION

The assignee of the present invention holds two patents referenced above for the use of ink-jet printing technology in the fabrication of refractive micro-optical elements, a technology which provides advantages over alternative technologies such as a 100-fold cost reduction and increased flexibility in micro-optics manufacture. The present invention involves the use of this micro-optics printing technology to print generally uniform axial gradient index of refraction microlenses. That is, the lenslets will have a base portion of optical polymeric fluid of a lower index of refraction, a top or cap portion of optical polymeric fluid of a higher index of refraction and an intermediate zone between the two which increases regularly in the axial vertical direction from the index of refraction of the base portion to the index of refraction of the top or cap portion. The purpose of printing microlenses having axial refraction index gradients is to reduce significantly the focal spot size of a lens of specified dimensions. This provides correspondingly significant performance advantages, such as increasing the microlens efficiencies in collimation and coupling of diode laser light sources into optical fibers or photodetectors, as well as improving their imaging quality. Modeling studies with standard ray-tracing software have shown that an axial variation of refractive index of 0.01 through a 50 micron high hemispherical microlens can reduce RMS (root mean square) focused spot radius by up to 50-fold, depending on the relative magnitudes of the axial and radial parameters of the gradient profile.

The microlenses or lenslets can be produced individually, or more usefully in an array of microlenses formed on an optical target substrate. Two printheads, typically heated printheads, are loaded with two mutually miscible thermoplastic or preferably thermosetting optical materials in the fluid state, which have significantly differing (ideally by 0.01 or more) indexes of refraction and are compatible with each other Ideally, these optical materials would be UV-curing (ultra-violet curing) optical epoxies which are maintained in their printhead fluid reservoirs at temperatures required to reduce their viscosities below the 30-40 centipoise threshold for microjetting by the drop-on-demand method. When droplets of such optical fluids are deposited, by a non-contacting printhead, at a targeted site onto an optical substrate, a spherically radiused element is formed as a section from a sphere. The fluid material spreads out on a surface to a degree determined by the viscosity of the material, the number and size of the deposited droplets, and the degree of wetting of the substrate surface by the material, in order to form plano-convex microlenses. The process includes the following four steps:

a. An ink-jet printhead containing a first optical material (first optical polymeric fluid) having the lower index of refraction is positioned above an optical target substrate site, and a specified number of droplets of this material are deposited at the site to form the base portion of a partially formed microlens.

b. An ink-jet printhead containing a second optical material (second optical polymeric fluid) having the higher index of refraction is positioned at the same location, and a specified number of droplets of this material is deposited at the same site as a cap portion of the second optical polymeric fluid over the base portion of the first optical polymeric fluid. The number of droplets of each optical material deposited to form the microlens would depend on the size of the desired microlens, the orifice sizes of the two printheads and the relative volumes of the two materials required to maximize the axial component of the index gradient of the microlens, as determined experimentally.

c. The microlens that has been formed is held under conditions which permit inter-diffusion of the cap portion and base portion for that period of time required to achieve the maximum and most uniform axial index of refraction gradient within the structure of the formed microlens. This ideal time period will depend upon the rheological properties of the two optical materials and, again, must be experimentally determined. Here the substrate may be heated to facilitate the inter-diffusion process or cooled to inhibit the inter-diffusion process of the two materials.

d. The formed microlens comprising the composite lenslet structure is solidified by whatever method is appropriate to the class of optical formulations employed, e.g., by UV-curing and then raising to an elevated temperature to the case of UV-curing optical epoxies.

To print an array consisting of multiple gradient of index refraction microlenses on an optical substrate, the same process is utilized, wherein all of the target sites may be printed first with the lower index first optical material and then all are printed again with the higher index second optical material on top of the lower index first optical material to make a plurality of composite microlenses. The inter-diffusion and solidification steps remain the same. Optimization of the degree of axial gradient index achieved for a given size of microlens will require maximization of the refractive index difference of the two optical fluids while retaining compatibility, and optimization of relative volumes of the two fluids, substrate temperature, and time allowed for diffusion prior to solidification and curing.

### BRIEF DESCRIPTION OF THE DRAWINGS

FIG. 1 is a schematic representation of a drop-on-demand ink-jet device;

FIG. 2 is a drawing representative of an actual photograph showing the repeatability and consistency of the drop making process;

FIG. 3 is a sketch of an actual array of microlenses formed on a substrate by ink-jet printer;

FIG. 4 illustrates the use of a single or gradient index microlens printed on the end of an optical fiber;

FIG. 5 illustrates the use of the printhead of FIG. 10 to print a base portion of a microlens on an optical substrate;

FIG. 6 illustrates use of the printhead of FIG. 10 to print a higher index of refraction optical polymeric fluid as an upper portion or cap portion over the base portion printed in FIG. 5.

FIG. 7 illustrates the generation of an axially gradient diffusion zone created in the product of FIG. 6 by holding the formed microlens under suitable diffusion conditions and curing after diffusion has progressed sufficiently;

FIG. 8 illustrates the focal spot produced by a single index microlens;

FIG. 9 illustrates the smaller focal spot produced by a gradient index microlens;

FIG. 10 illustrates a printhead having two temperature controlled chambers and two ejection heads connected to the chambers for depositing a low index optical fluid and a high index optical fluid at a target site;

FIG. 11 is a photograph of a microlens formed by the process of the invention simulating an axially gradient index of refraction;

FIG. 12 is a chart indicating suitable fluid properties considerations and lens properties considerations for gradient index lenses made from optical polymeric materials.

### DETAILED DESCRIPTION OF THE PREFERRED EMBODIMENT

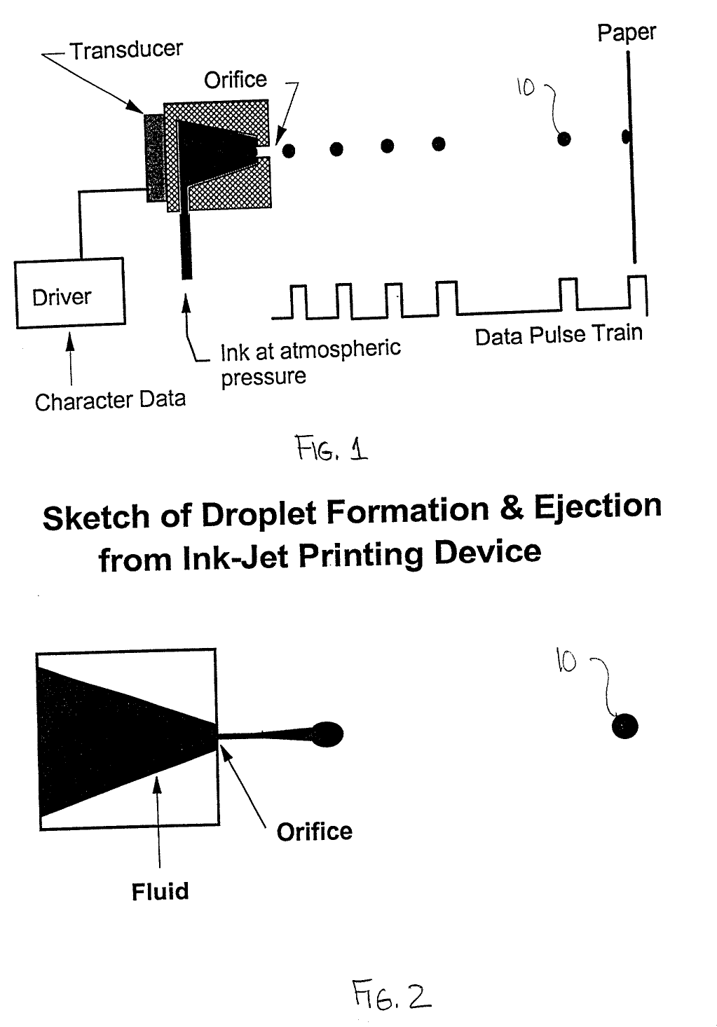

The present invention preferably utilizes drop-on-demand ink-jet technology. In piezoelectric-based, drop-on-demand ink-jet printing systems, illustrated schematically in FIG. 1, a volumetric change in the fluid within a printing device is induced by the application of a voltage pulse to a piezoelectric transducer which is coupled to the fluid. The volumetric change causes pressure/velocity transients to occur in the fluid which are directed to produce a drop from the orifice of the device. Here a voltage pulse is applied only when a drop is desired, as opposed to continuous ink-jet printers where droplets are continuously produced, but directed to the target substrate only when needed by a charge and deflect method. Further details about the ink-jet printing systems and control apparatus is found in U.S. Pat. Nos. 5,498,444 and 5,707,684 which are incorporated herein by reference.

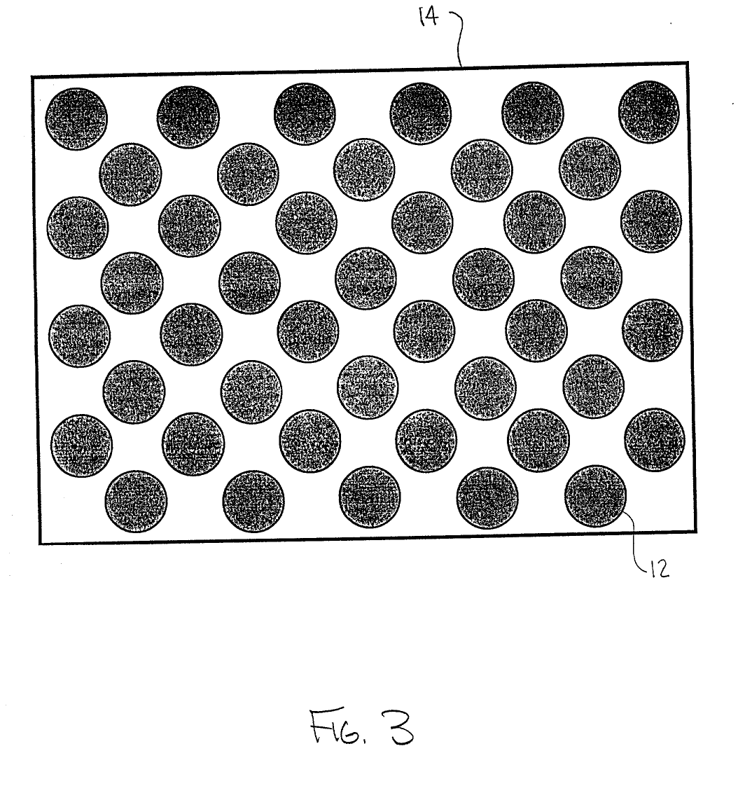

One of the characteristics of ink-jet printing technology that makes it generally attractive for a precision fluid microdispensing method is the repeatability of the process. FIG. 2 is drawing of an actual photograph of a drop-on-demand ink-jet printing device with a 50 micron orifice operating at a frequency of 2,000 droplets per second, illuminated by an LED that was pulsed at the same frequency. With a camera exposure time of ½ second, the droplet image seen here is actually the superposition in space of 1,000 droplets, illustrating the spatial and temporal stability of the microjetting process. The drawing accurately represents the photograph wherein the droplet 10 represents 1,000 actual microdroplets.

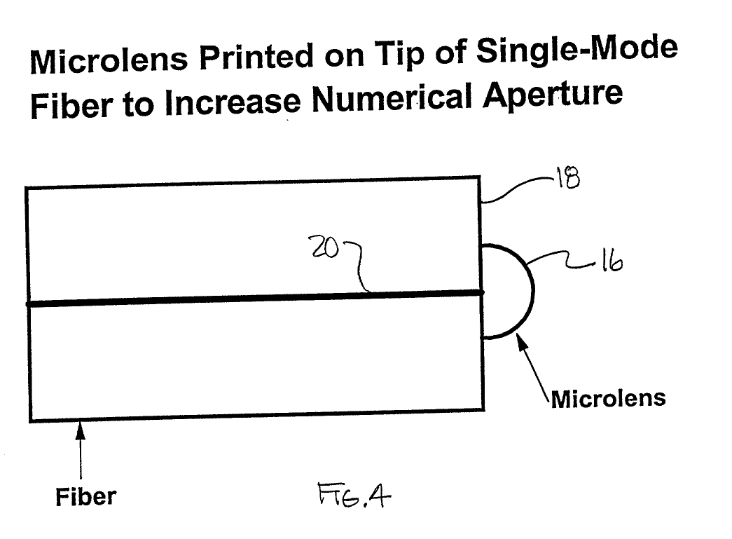

Examples of hemispherical microlenses fabricated by drop-on-demand ink-jet printing of multiple 50 micron droplets of a UV-curing optical epoxy at specified target locations are shown in FIGS. 3 and 4. FIG. 3 is a graphical representation of an actual photograph of an array of 330 micron diameter lenslets 12 for use in a “smart-pixel” based datacom switch. The lenslets are printed on an optical substrate 14 which allows passage of light, such as a glass slide, silicon wafer or the tips of optical fibers. Depending upon the optical substances employed, the droplets can be solidified by UV-curing, heating. Here the volume of the printed lenslets 12 is determined by the number and size of microdrops deposited at the target site. The aspect ratio (diameter/height) of the microlens is adjusted by controlling the degree of spread of the deposited material on the substrate material prior to solidification, e.g., via variation of fluid viscosity or substrate wettability. The pattern is obtained by means of a computer controlled XY stage that moves the substrate a finite distance and direction after the lenslets 12 are formed as indicated in U.S. Pat. No. 5,707,684. Alternately, the printhead can be moved relative to the substrate in a similar manner. FIG. 4 is a graphical representation of an actual photograph of a 70 micron diameter lenslet 16 printed onto the tip of a 125 micron optical fiber 18 centered over the core 20 of the optical fiber to increase acceptance angle (NA) for incoming light. Applications such as this can be used to increase the efficiency of light collected by the fiber.

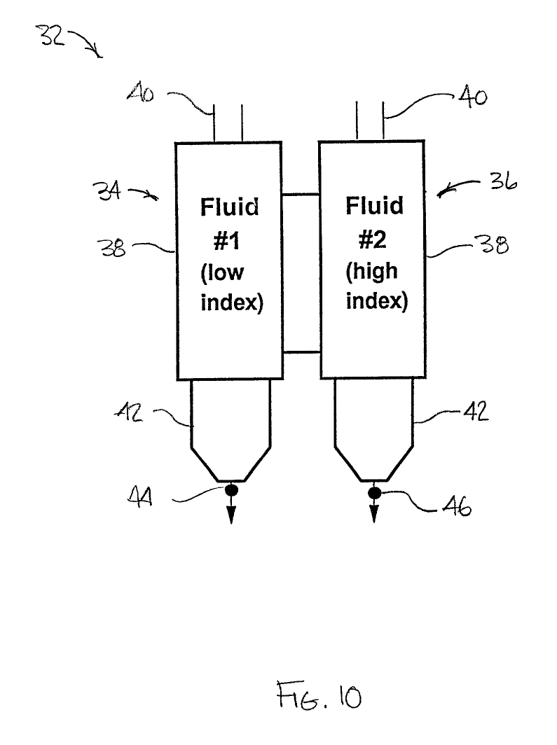

FIGS. 5-7 illustrate the process for fabricating axial gradient index microlenses in optical polymeric fluids using an ink-jet printhead. In FIG. 5 a series of microdroplets 10 are deposited on an optical substrate 14 in a first series of droplets of a first optical polymeric fluid and coalescing these droplets to form the base portion 22 of a partially formed microlens. The depositing and coalescing steps occur naturally and substantially simultaneously to form a radiused spherical section on substrate 14. This first material will have the lower index of refraction. The printhead can be programmed to print a given number of droplets whereupon the substrate is indexed and the printhead repeats the same number of droplets to reproduce base portion 22 any number of times to form an array of base portions 22 on substrate 14.

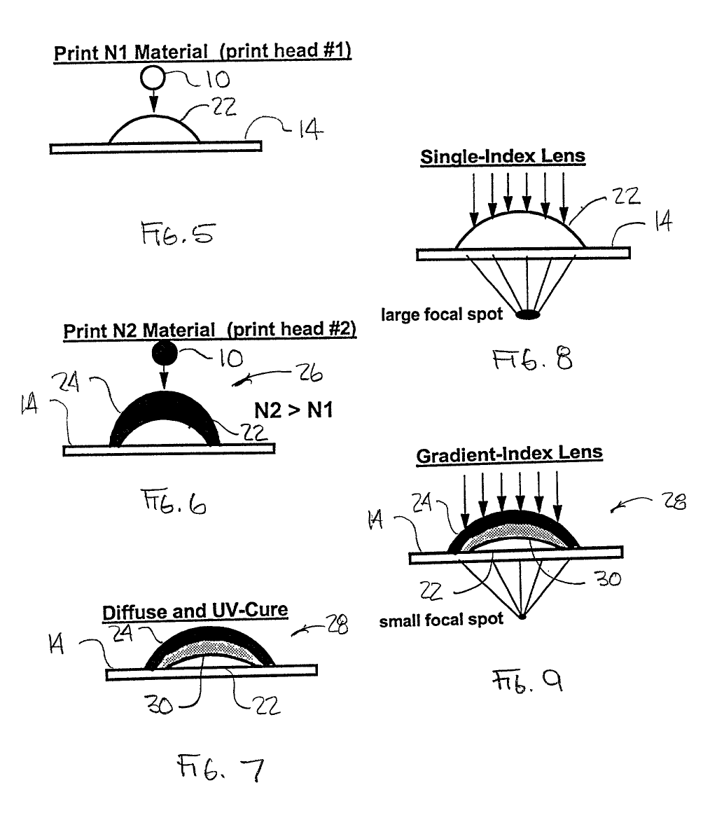

FIG. 6 illustrates the depositing of a compatible second optical polymeric fluid, preferably from a second printhead (FIG. 10). A second series of droplets of a second optical polymeric fluid compatible with the first optical polymeric fluid are deposited from a second ink-jet printhead onto the partially formed microlens wherein the second optical polymeric fluid has an index of refraction higher than that of the first optical polymeric fluid. This is illustrated by the expression N2 greater than N1. The second series of droplets of the second optical polymeric fluid are coalesced to create a fully formed microlens having a base portion 22 of the first optical polymeric fluid under a cap portion 24 of the second optical polymeric fluid. The relative volume of the base portion 22 and cap portion 24 are mainly controlled by the number of droplets 10 used to create the respective portions. These two materials must be Theologically compatible, e.g., miscible and similar in viscosity, and the magnitude of the gradient achieved will be determined by the magnitude of the difference in their refractive indexes.

After the steps shown in FIGS. 5 and 6, the next step is to hold the formed microlens 26 under conditions which permit inter-diffusion of the cap portion and the base portion to create an axially gradient index of refraction in the formed microlens 28. Normally this would involve holding for a time at an elevated temperature. Schematically shown is part of the original cap portion 24, part of the original base portion 22 and an inter-diffused portion 30 (zone) which has a gradient in the axial (vertical) direction. The index of refraction is increasing from the index of base portion 22 at the bottom of inter-diffusion zone 30 to the index of refraction of the cap portion 24 at the upper boundary of the inter-diffusion zone 30. It is expected that the operating parameters to create the axial gradient index microlens will be determined experimentally to achieve the desired results.

The final step not illustrated in the drawings is the step of solidifying the formed microlens 28 after a time period required to obtain a desired degree of gradient in the index of refraction of the formed microlens. This is preferably achieved by using UV-curable first and second optical polymeric fluids and curing them with a combination of UV radiation followed by holding at an elevated temperature to insure that curing is complete. Heat curable optical materials could be cured by the application of heat for a period of time at elevated temperature whereas thermoplastic materials may be solidified by allowing them to cool or placing them in a cooler to solidify them. Once the operating parameters are determined to achieve the desired result, replication of the desired result should be possible.

FIGS. 8 and 9 represent graphically the difference between a single index lens in FIG. 8 formed from a single optical polymeric fluid (as in FIG. 5) to the gradient index lens in FIG. 9 formed as indicated in FIGS. 5-7. Light is indicated by the arrows. The gradient index lens mitigates the well known characteristic spherical aberration to produce a significantly smaller focal spot for lenslets of the same geometry. Focal spot can be measured with a standard beam analyzer by well known techniques. The smaller focal spot creates a greater efficiency of coupling of light into optical fibers, photodetectors or imaging applications. The focal length may be reduced somewhat as well as the focal spot in as much as higher index material generally has a shorter focal length.

FIG. 10 schematically represents a dual printhead assembly which is preferably used for depositing different optical materials at the same target site to print axial gradient index microlenses. In FIG. 10, the dual printhead 32 has a first printhead 34 and a second printhead 36 which are essentially the same. First printhead 34 has a temperature controlled reservoir 38 containing the low index first optical polymeric fluid. Second printhead 36 has a temperature controlled fluid reservoir containing the second optical polymer fluid having a higher index of refraction. The reservoirs are preferably connected to a source of vacuum or pressure 40 which is useful for initiating and maintaining droplet formation and for drawing the unejected optical fluid material out of the preferably piezoelectric jetting devices 42 between runs. A drop 44 of low index optical fluid is seen being ejected from first printhead 34 and a drop 46 of higher index optical fluid is seen being ejected from second printhead 36. A suitable printhead having a heated fluid chamber is disclosed in U.S. Pat. No. 5,772,106, which is incorporated herein by reference. Although this printhead was developed for ejection of solder droplets, it is adaptable for polymers that require substantial elevated temperature to reduce the viscosity to a printable level. Many of the most useful optical polymeric formulations require heating to the 130-165° range to reduce the viscosity below the about 40 centipoise level required for dispensing by drop-on-demand ink-jet printing.

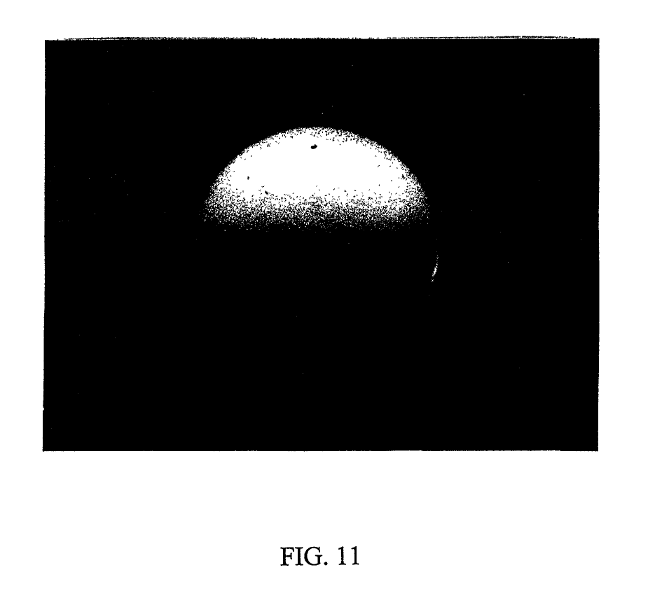

A photograph illustrating the process of erecting an axial gradient index microlens is shown in FIG. 11. Firstly, 60 droplets, each 50 microns in diameter, of a UV-curing optical epoxy pre-polymer formulation were ink-jet printed from one printhead onto a glass slide at room temperature which had a transparent, de-wetting coating to minimize flow of deposited materials. Secondly, 40 droplets, of the same diameter, consisting of the same formulation as the first, but with the addition of fluorescein, were printed from a second printhead directly on top of the first deposit. After allowing 30 minutes for inter-diffusion, the 300 micron diameter, plano-convex microlens thus formed was cured by ultraviolet light. The photograph was taken with the lenslet in profile using an optical microscope at a magnification of 150×, under both UV and low-level-visible illumination such that the second, fluorescing material shows to be light in color while the first appears much darker. In the photo one can see both the image of the microlens (top portion of photo) and, much less discernable, the reflected image of the lenslet (bottom portion of the photo), the substrate plane being where these two images are joined in the middle of the photograph. The uniform change in color from dark to light as one moves upward from the substrate (plano side) to the top of the lenslet (convex side) demonstrates that a microlens with uniform axial gradient in composition can be fabricated by this method. That is, if these two formulations differed in refractive index, rather than the presence or lack of fluorescing material as in the case shown, a uniform axial index of refraction would have been created.

It has also been found that the aspect ratio of the lens to be formed can be altered by selecting a substrate which is not wettable by the optical material to be deposited or only partly wettable by the material or where a de-wetting coating has been applied to the surface of the substrate on which the deposits will be made.

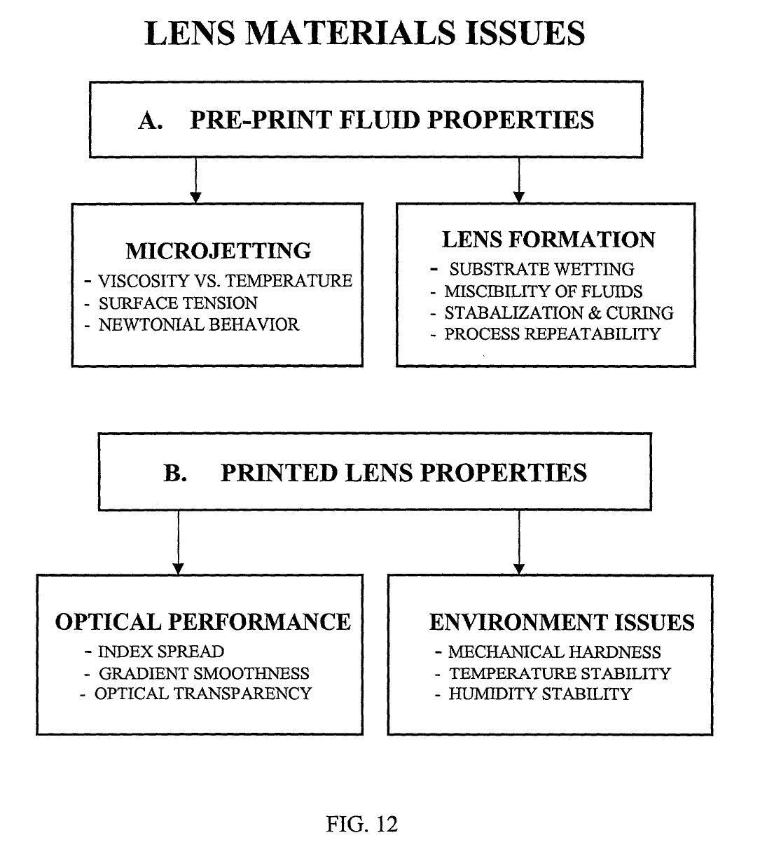

When considering development of an optical material system for ink-jet printing of optical elements, there are two categories of issues/requirements to be addressed relating to fluid and printed element properties as indicated in FIG. 12. Fluid formulations, firstly, must meet certain rheological requirements, e.g., viscosity must be less than about 40 centipoise to be dispensed by the drop-on-demand ink-jet printing process, and, secondly must have the wetting, curing and interaction properties needed for the application. For microjetting, the viscosity must be reducible by a suitable temperature. Surface tension and Newtonian behavior will have an effect on formation of spherical lens sections. In addition, substrate wetting will produce a flatter (larger radius) lens whereas substrate non-wetting will produce a smaller radiused lens. For gradient lenses, the miscibility of the first and second optical polymeric fluids must be such that they are able to merge into a single lens without a light interfering boundary layer being formed. Stabilization and curing of the materials is important as well as process repeatability.

In the printed lens optical performance is affected by the spread of the refractive index between the first and second optical materials, the degree of smoothness of the gradient and the optical transparency of the completed lens. The lens itself must have sufficient mechanical hardness, temperature stability and humidity stability for optical applications. Generally, optical materials must be able to withstand 85° centigrade in 85% relative humidity without degradation.

An examination of the specifications of commercially available monomers, pre-polymers and cationic UV and thermal initiators will enable selection of a range of such materials likely to meet most of these requirements. Candidate commercial polymers and pre-polymers include: Probimides from Arch Chemicals, Inc.; Ultems and UltemLCs from General Electric; Ultadel series from Amoco; Cyclotenes from Dow Chemical; polymethylmethacrylate (PMM4) and other methacrylates from various sources. These polymers and pre-polymers to be considered cover a broad chemical spectrum and include: polyimides; fluorinated polyimides; polyetherimides; polybenzocyclobutenes; polycarbonates; polyacrylics; fluorinated polyacrylics; modified cellulose/acrylics; polyquinolates; polystyrenics; polyesters; and polymers/prepolymers comprising monomers having reactive functionality selected from epoxy, cyanato or maleimido groups. Estimates of refractive index for different fluids may be determined microscopically using index matching fluids.

Some specific commercial materials which have been suitable for forming axial gradient index microlenses include Summers Optical No. SK9 (Refractive Index 1.49) by Summers Optical, Inc., P.O. Box 162, Fort Washington, Pa., 19034; Norland No. NOA-73 (Refractive Index 1.56) by Norland Products, Inc., P.O. Box 7145, New Brunswick, N.Y., 08902; and Epotek No. OG146 (Refractive Index 1.48) by Epoxy Technology, Inc., 14 Fortune Dr., Billerica, Mass., 01821.

It is believed that at room temperature viscosity should not be over 1000 centipoise and the viscosity must be reduced below about 40 centipoise by heating up to perhaps as high as 150 to 200° centigrade in the printhead or by the use of organic solvents which then must be heated to drive them out of the finished product. The preferred way is to operate with polymeric materials having 100% solids. The removal of solvents results in shrinkage and distortion. Ray-trace modeling for lens geometry is preferably performed using a Zemax, optical design program version 9.0, Focus Software, Inc., P.O. Box 18228, Tucson, Ariz. If it is desired to apply a de-wetting coating to the surface of the substrate to inhibit spreading, a suitable material is known as FC-724 by 3M Corporation, St. Paul, Minn. It is believed to be a fluorinated acrylate de-watering liquid which adheres to glass or plastic surfaces.

This invention provides, for the first time, a way to fabricate axial gradient index microlenses in plano-convex (vs. planar) configuration and with plastic (vs. glass) optical materials. Additionally, since microjet printing of micro-optics is a fully automated, data-driven and in-situ process, it may be used to fabricate similarly sized microlenses having varying degrees of axial index gradient on the same target substrate, by varying precisely the relative amounts of the two optical fluids being deposited at each lenslet site. Finally, anamorphic microlenses, e.g., of hemi-cylindrical, hemi-eliptical or rectangular (vs. hemispherical) shape may also be formed with gradient indexes of refraction by this method.

Although the invention has been disclosed above with regard to a particular and preferred embodiment, it is not intended to limit the scope of this invention. For instance, although the inventive method has been set forth in a prescribed sequence of steps, it is understood that the disclosed sequence of steps may be varied. It will be appreciated that various modifications, alternatives, variations, etc. may be made without departing from the spirit and scope of the invention as defined in the appended claims.

What is claimed:

1. A method of fabricating gradient-index microlenses in optical polymeric fluids using an ink-jet printhead, comprising:
depositing a first series of droplets of a first optical polymeric fluid having an index of refraction, from an ink-jet printhead, onto a substrate;
coalescing said first series of droplets to form the base portion of a partially formed microlens;
depositing a second series of droplets of a second optical polymeric fluid compatible with said first optical polymeric fluid from an ink-jet printhead onto the partially formed microlens, the second optical polymeric fluid having an index of refraction higher than that of said first optical polymeric fluid;
coalescing said second series of droplets to create a fully formed microlens having a base portion of the first optical polymeric fluid under a cap portion of the second optical polymeric fluid;
holding the formed microlens under conditions which permit inter-diffusion of the cap portion and the base portion to create a generally uniform axially gradient index of refraction in the formed microlens; and
solidifying the formed microlens after a time period calculated to retain a desired degree and uniformity of gradient in the index of refraction of the formed microlens;
wherein the formed microlens has a reduced focal spot for optical uses as compared to a non-gradient index microlens of the same character.

2. The method of claim 1 wherein the step of depositing a second series of droplets of a second optical polymeric fluid compatible with the first optical polymeric fluid comprises the step of depositing a second optical polymeric fluid having an index of refraction about 0.01 or greater than the index of refraction of the first optical polymeric fluid.

3. The method of claim 2 wherein the depositing and coalescing steps are performed relatively simultaneously wherein previous drops are coalescing while additional drops are being deposited.

4. The method of claim 3 wherein the step of depositing a first series of droplets of a first optical polymeric fluid is performed with a printhead heated to an elevated temperature selected to reduce the viscosity of the first optical polymeric fluid to less than about 40 centipoise.

5. The method of claim 4 wherein the step of depositing a second optical polymeric fluid is performed with a printhead depositing the second series of droplets of a second optical polymeric fluid which is heated to an elevated temperature sufficient to reduce the viscosity of the second optical polymeric fluid to less than about 40 centipoise.

6. The method of claim 3 wherein the steps of depositing first and second optical polymeric fluids comprise the steps of depositing first and second optical polymeric fluids selected from the group consisting of pre-polymers and polymers.

7. The method of claim 6 wherein the steps of depositing first and second optical polymeric fluids comprises the step of depositing at least one of the fluids in the group consisting of polyimides; fluorinated polyimides; polyetherimides; polybenzocyclobutenes; polycarbonates; polyacrylics; fluorinated polyacrylics; modified cellulose/acrylics; polyquinolates; polystyrenics; polyesters; and polymers/pre-polymers comprising monomers having reactive functionality selected from epoxy, cyanato or maleimido groups.

8. The method of claim 3 where in the step of depositing first and second optical polymeric fluids comprises the step of depositing at least one first or at best one second optical polymeric fluid which is heat or UV curable and the solidifying step is accomplished by applying heat or UV radiation to the formed microlens after the holding step.

9. The method of claim 1 wherein at least one of the first and second optical polymeric fluids is a UV curable pre-polymer and further including the step of exposing at least one of the first or second optical polymeric fluids to UV radiation during the depositing step to help control the aspect ratio/shape of the formed microlens.

10. The method of claim 1 wherein the step of depositing a first series of droplets of a first optical polymeric fluid from an ink-jet printhead onto a substrate comprises the step of depositing said first optical polymeric fluid onto a substrate having a surface treated to be non-wetting with respect to the first optical polymeric fluid to help control the aspect ratio of the formed microlens.

11. A method of fabricating an array of gradient-index microlenses in optical polymeric fluids using an ink-jet printhead, comprising:
providing an ink-jet printhead adapted to deposit a series of droplets of a first optical polymeric fluid from a first orifice and a second series of droplets of a second optical polymeric fluid from a second orifice, wherein the first and second optical polymeric fluids are compatible and the second optical polymeric fluid has a higher index of refraction than the first optical polymeric fluid;
operating the first orifice to deposit a series of droplets of the first optical polymeric fluid at each of a plurality of sites on a substrate to form the base portion of a partially formed microlens at each of the plurality of sites on the substrate;
operating the second orifice to deposit a series of droplets of the second optical polymeric fluid at each of the plurality of sites on the substrate to form cap portions of the second optical polymeric fluid over the base portions of first optical polymeric fluids at the plurality of sites to form an array of microlenses having a base portion of the first optical polymeric fluid and a cap portion of the second optical polymeric fluid;
holding the array of microlenses at a temperature for a diffusion time which permits inter-diffusion of the cap portion and base portion of each microlens to create a generally uniform intermediate zone having a generally uniform axially gradient index of refraction in the microlens in said array; and
solidifying the microlenses in said array to maintain the axial gradient that has been formed in the array of microlenses.

12. The method of claim 11 wherein the step of operating the second orifice to deposit a series of droplets of the second optical polymeric fluid at each of the plurality of sites comprises the step of depositing a second optical polymeric having an index of refraction about 0.01 or greater than the index of refraction of the first optical polymeric fluid.

13. The method of claim 12 wherein the substrate is moved relative to the printhead in order to move the orifices from site to site.

14. The method of claim 12 wherein the printhead is moved relative to the substrate in order to move the orifices from site to site.

15. The method of claim 11 wherein the step of depositing a series of droplets of the first optical polymeric fluid includes the step of heating said first optical polymeric fluid to an elevated temperature sufficient to reduce the viscosity of the first optical polymeric fluid to less than about 40 centipoise.

16. The method of claim 15 wherein the step of depositing a series of droplets of the second optical polymeric fluid includes the step of heating the second optical polymeric fluid to reduce the viscosity of the second optical polymeric fluid to less than about 40 centipoise.

17. The method of claim 12 wherein the steps of operating the first and second orifices to deposit said first and second optical polymeric fluids comprise the step of depositing first and second optical polymeric fluids selected from the group consisting of pre-polymers and polymers.

18. The method of claim 16 wherein the steps of operating the first and second orifices to deposit first and second optical polymeric fluids comprises the step of depositing said first and second optical fluids wherein at least one of the fluids come from the group consisting of polyimides; fluorinated polyimides; polyetherimides; polybenzocyclobutenes; polycarbonates; polyacrylics; fluorinated polyacrylics; modified cellulose/acrylics; polyquinolates; polystyrenics; polyesters; and polymers/pre-polymers comprising monomers having reactive functionality selected from epoxy, cyanato or maleimido groups.

19. The method of claim 12 wherein the steps of depositing a series of droplets of the first and second optical polymeric fluids comprise the step of depositing first or second optical polymeric fluids which are heat or UV-curable and the solidifying step is accomplished by the step of applying heat or UV radiation to the formed microlens.

20. The method of claim 11 wherein the step of operating the first orifice to deposit a series of droplets of the first optical polymeric fluid at each of a plurality of sites on a substrate comprises the step of depositing said first optical polymeric fluid onto a substrate having a surface treated to be non-wetting with respect to the first optical polymeric fluid to help control the aspect ratio of the base portion of the partially formed microlens.
